(19) United States
(12) Patent Application Publication
(10) Pub. No.: US 2017/0053515 A1
(43) Pub. Date: Feb. 23, 2017

(54) Retriever Locator

(71) Applicant: Ralph K. Dyer, Boynton Beach, FL (US)

(72) Inventor: Ralph K. Dyer, Boynton Beach, FL (US)

(21) Appl. No.: 14/831,936

(22) Filed: Aug. 21, 2015

(51) Int. Cl. G08B 21/24

(52) U.S. Cl. CPC G08B 21/24

(57) ABSTRACT

A selectable lost item retriever locator system to locate the predetermined lost and/or stolen items, comprising a hand-held receiver or locator unit and chips applied to items the user desires to locate, is disclosed. The receiver or locator unit is a hand held device, either a smartphone app or a component that picks up signals like a remote or a key clicker device. The receiver or locator unit would retrieve the item as the user get close to it either by beeping or flashing the light. The chips act as the tracking unit, where the tracking module may be a global positioning system (GPS) for longer distances and remote or clicker device to locate the lost and/or stolen items at 0.1 to 200 feet distances.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

Field of the Invention

The present invention relates to lost item locators and, more particularly, to a new selectable lost item retriever locator system for finding particular items either misplaced or lost.

Background of the Invention

In the related art, it has long been known to use various kinds of apparatus or systems that afford a unique method of identifying the location of a plurality of missing or lost items. Objects that are easily lost include television remote controls, portable telephones, check books, purses, etc. Searching for lost or misplaced objects is often a very time-consuming task.

The use of lost item locators is known in the prior art. More specifically, the lost item locators heretofore devised and utilized are known to consist basically of familiar, expected and obvious structural configurations, notwithstanding the myriad of designs encompassed by the crowded prior art which have been developed for the fulfilment of countless objectives and requirements.

U.S. Pat. No. 5,939,981, issued to Renney, is a device which functions to locate pre-selected items which are remote from a user. The device comprises two parts; a hand held device and multiple sensors/chips which are applied to objects the user desires to locate. The hand held devices contains a control panel selector buttons for each multiple sensors/chip it is desired to locate. When a pre-selected button is depressed, a transmitter sends signal containing pre-selected code. The signal is received by a receiver in each multiple sensors /chip. The receiver in each multiple sensors/chip reads the code and if a match is obtained the receiver enables an audio tone generator in the multiple sensors/chip to send a tone through an audio speaker.

U.S. Pat. No. 7,301,453, issued to Terry L. Fry, discloses the method for locating a person or article preferably uses an audible feedback signal to the user for informing the user, when moving, whether the relative position of the beacon tag is getting closer to the finder or farther from the finder. The locator system includes at least one beacon tag comprising a transmitter programmed to transmit a unique coded pulse signal.

U.S. Pat. No. 7,420,465 issued to Rudolf Ritter, concerns to a method for finding lost or stolen objects, including products, intellectual property, persons and animals, on the basis of RFID (Radio Frequency Identification) tags. This pertains to reading a RFID tag affixed to the object and through pairing of identification in the tag with identification in the owner's SIM card. If the tag is read with an RFID reader device in the mobile device or connected with the mobile device, this pairing can be performed automatically by the RFID reader device.

While these devices fulfil their respective, particular objectives and requirements, the aforementioned patents do not disclose a new selectable lost item retriever locator system. What is needed is a system or method that solves one or more of the problems described herein and/or one or more problems that may come to the attention of one skilled in the art upon becoming familiar with this specification.

### SUMMARY OF THE INVENTION

In view of the foregoing disadvantages inherent in the known types of item locator devices and systems now present in the prior art, the present invention provides a new selectable lost item retriever locator system wherein the has been developed to provide a security system for tracking lost or stolen items and use on process of various components employed in the procedure. As such, the general purpose of the present invention, which will be described subsequently in greater detail, is to provide a new and improved selectable lost item retriever locator system which has all the advantages of the prior art and none of the disadvantages.

Accordingly, it is a primary aspect of the present invention to provide a new selectable lost item retriever locator system to track the lost or stolen items. For the purpose, chips are provided which are applied to objects the user desires to locate.

In another aspect, the present invention provides a hand held device which functions to locate the preselected items which are remote from the user.

It is yet another aspect of the present invention where the handheld device can either a smartphone app or a component that picks up signals like a remote or a key clicker device.

In still another aspect, the present invention provides a new selectable lost item retriever locator system where the tracking module may be a global positioning system (GPS), similar to a low jack system.

In still another aspect, the present invention provides a new selectable lost item retriever locator system where the receiver or locator unit would retrieve the item as the user get close to it either by beeping or flashing the light.

Further aspect of the present invention provides an economical, reliable, robust and easy to use selectable lost item retriever locator system for tracking the lost or stolen items.

It is a yet another aspect of the present invention to provide a new and improved selectable lost item retriever locator system which is of a durable and reliable construction.

It is a yet another aspect of the present invention to provide a new and improved selectable lost item retriever locator system which is of a jewellery.

It is a yet another aspect of the present invention to provide a new and improved selectable lost item retriever locator system which is of a waterproof construction.

Further the retriever locator system in another embodiment of the invention comprises of a panic button connected to the microchip for a person to be able to signal for help.

Other aspects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof Such description makes reference to the annexed drawings wherein:

FIG. 1 is a perspective view of the retriever chips located on the various utility items.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

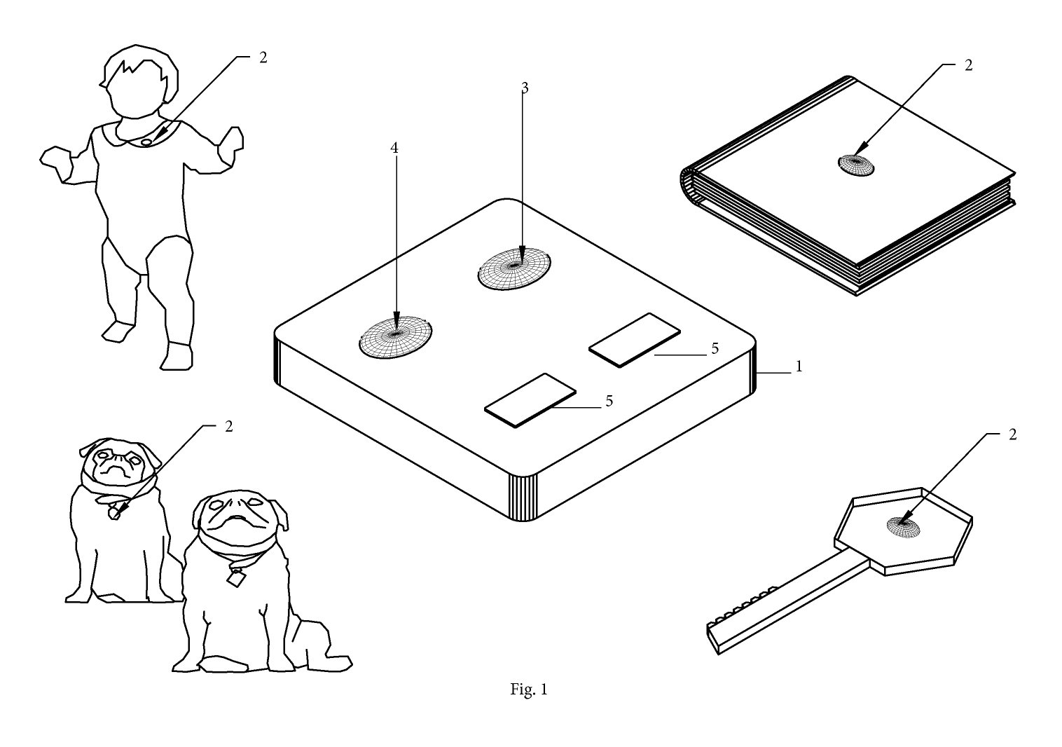

In some preferred embodiments, the present invention FIG. 1 provides a selectable lost item retriever locator system which functions to locate the preselected items which are remote from a user. The present invention comprises two parts; a hand held device 1 and chips 2 which are applied to items the user desires to locate. The receiver or locator unit 3 provided by the hand held device is either a smartphone app or a component that picks up signals like a remote or a key clicker device. The receiver or locator unit would retrieve the item 4 as the user get close to it either by beeping or flashing the light. The chips act as the tracking unit, where the tracking module may be a global positioning system (GPS), similar to a low jack system.

In further embodiment, the hand held devices, measures 2 inch by 3 inch, contains a control panel selector buttons 5 for each chip it is desired to locate. When a preselected button is depressed, a transmitter sends signal containing preselected code. The signal is received by a receiver in each chip. The receiver in each chip reads the code and if a match is obtained the receiver enables a beep or flashes the light in the chip to send the notification for the lost item, indicating the user thereof.

In one embodiment, the chip works by communicating with the app and GPS on the phone. The chip, thus, send a signal to the phone to beep when close to lost item. In one embodiment, for longer distances, the GPS in the smartphone and chip is utilized to locate the lost or stolen items. In one embodiment, the present system utilizes the remote or clicker device to locate the lost or stolen item at shorter distances as 0.1 to 200 feet. The chip also can be a part of a jewelery helping the owner to locate the lost jewellery.

In accordance with the invention, the selectable lost item retriever locator system also comprises a plurality of receiver assemblies each including a housing member, and also including a receiver chip being conventionally disposed in the housing member, and further including a beep-producing member and/or light-flashing member being conventionally attached to the housing member and being conventionally connected to the receiver chip. The waterproof materials are used for production of the chip itself and the housing member. Each of the receiver assemblies further includes a microprocessor being conventionally disposed in the housing member, and also includes a power source for energizing the microprocessor and the receiver chips. Each receiver includes a unique radio frequency chip for responding to a unique frequency radio wave being transmitted by the variable radio transmitter. Further the retriever locator system in another embodiment of the invention comprises of a panic button connected to the microchip for a person to be able to signal for help.

As may now be appreciated from the above description and reference to the accompanying drawings, the present invention provides a selectable lost item retriever locator system which may be utilized by the user to locate the lost or stolen predetermine item.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A selectable lost item retriever locator system for location of lost or stolen items comprising:
a hand-held receiver unit to locate the predetermined lost and/or stolen items;
a tracking module; and
chip attached to the predetermined items the user desires to locate.

2. (canceled)

3. A selectable lost item retriever locator system as claimed in claim 1, wherein said receiver-unit is a smartphone app.

4. A selectable lost item retriever locator system as claimed in claim 1, wherein said receiver unit picks up signals remotely.

5. A selectable lost item retriever locator system as claimed in claim 1, wherein said receiver-unit retrieves the item by beeping.

6. A selectable lost item retriever locator system as claimed in claim 1, wherein said receiver unit retrieves the item by or flashing the light.

7. A selectable lost item retriever locator system as claimed in claim 1, wherein said receiver unit retrieves the item s the user get close to by beeping and flashing the light.

8. A selectable lost item retriever locator system as claimed in claim 1, wherein said chips is a tracking unit.

9. A selectable lost item retriever locator system as claimed in claim 1, wherein said chips made of waterproof material.

10. A selectable lost item retriever locator system as claimed in claim 1, wherein said chips made of waterproof material.

11. A selectable lost item retriever locator system as claimed in claim 1, wherein said chips is a jewelry piece.

12. A selectable lost item retriever locator system as claimed in claim 1, wherein said tracking module is a global positioning system (GPS).

13. A selectable lost item retriever locator system as claimed in claim 1, wherein said tracking module operates at 0.1 to 200 feet distance range.
